(19) United States
(12) Patent Application Publication
(10) Pub. No.: US 2024/0347833 A1
(43) Pub. Date: Oct. 17, 2024

(54) Housing Element, Energy Store Housing, and Process for Manufacturing a Housing Element

(71) Applicant: Bayerische Motoren Werke Aktiengesellschaft, Muenchen (DE)

(72) Inventors: Ahmed EL-SAWY, Muenchen (DE); Oleg KONRAD, Hohenthann Weihenstephan (DE); Manuel SCHURZ, Landshut (DE); Marcel STERZENBACH, Essenbach (DE)

(21) Appl. No.: 18/294,655

(22) PCT Filed: Jul. 12, 2022
(86) PCT No.: PCT/EP2022/069384

§ 371 Date: Feb. 2, 2024

(30) Foreign Application Priority Data
Aug. 3, 2021 (DE) 10 2021 120 082.2

(51) Int. Cl. H01M 50/231; H01M 50/224; H01M 50/233; H01M 50/262

(52) U.S. Cl. CPC H01M 50/231; H01M 50/224; H01M 50/233; H01M 50/262

(57) ABSTRACT

A housing element for an energy store housing has a placement or arrangement area designed to arrange a multiplicity of energy storage cells thereon, the housing element being double-walled in the arrangement area, that is it has an outer wall and an inner wall. The outer wall is formed by a lightweight metal sheet, in particular an aluminum sheet, and the inner wall is formed by a reinforcement element that is arranged on the outer wall.

### BACKGROUND AND SUMMARY

The present invention relates to a housing element for energy store housings, to an energy store housing, and to a method for producing a housing element.

In order to comply with demanded ranges, partially and fully electric motor vehicles have large energy stores which require correspondingly large energy store housings. In the case of passenger cars, such energy store housings often take up a large area of the underbody of the respective vehicle. The production of such housings entails a series of challenges. What is problematic in this connection in particular is the weight. Owing to the size of the components, certain restrictions in terms of the manufacturing methods available also arise. As a result, it is not readily possible from a plant technology perspective, for example, to produce die-cast components of any desired size. Owing to the often exposed installation situation, cf. the aforementioned underbody, the requirements in terms of crash behavior or other mechanical effects and also corrosion protection are also important themes. High requirements are also placed on such housings if there is a thermal event inside the energy store itself.

It is therefore an object of the present invention to provide a housing element for an energy store housing, an energy store housing, and a method for producing a housing element, the intention being to eliminate the aforementioned disadvantages and in particular to provide a housing element which is inexpensive to manufacture in the case of optimum mechanical properties.

This object is achieved by a housing element, by an energy store housing, and by a method, in accordance with the independent claims. Further advantages and features will emerge from the dependent claims, the description and the appended figures.

According to the invention, a housing element for an energy store housing comprises an arrangement region, which is designed for the arrangement of a multiplicity of energy storage cells, wherein the housing element in the arrangement region has a double-walled form at least in certain regions, preferably over the entire surface area, comprising an outer wall and an inner wall, wherein the outer wall is formed by a light-metal sheet, in particular an aluminum sheet, and wherein the inner wall is formed by a reinforcing element arranged on the outer wall. Expediently, the use of a light-metal sheet, such as the aluminum sheet, affords the advantage that complex corrosion protection can be omitted. In addition, the aluminum sheet is distinguished, for example, by its low specific weight. The reinforcing element can explicitly be designed for reinforcing the outer wall in the arrangement region, the reinforcement being meant to be with respect to mechanical effects both from “outside” and from “inside”, if there is a thermal event in the energy store. In this case, it is possible for there to be an explosion-like pressure increase in the energy store, which places high requirements on the ability of the energy store housing and its constituent parts to bear thermal/mechanical loads. In the present case, these requirements can be met advantageously and selectively by way of the reinforcing element, while the housing element as such, in particular in the region of the arrangement region, is produced inexpensively from an aluminum sheet.

According to a particularly preferred embodiment, the reinforcing element is a steel sheet. The use of steel as material is advantageous since it is relatively favorable and offers many advantages in terms of function, for example in the event of crash loads. To be emphasized in this connection are in particular the high tensile strength and high toughness of steel materials. Advantageously, the steel layer enables very good thermal protection if there is a thermal event, as already described. In the event of a short circuit inside a high-voltage store, temperatures of up to 1000° C. and more can arise, which would cause aluminum to melt. The steel sheet advantageously enables selective and permanent reinforcement of the housing element.

According to one embodiment, the steel material used is a high-strength steel. For example, this enables the thin wall thicknesses down to 0.3 mm mentioned below.

According to a preferred embodiment, the reinforcing element is provided with an anti-corrosion layer on one side or both sides. A steel sheet is preferably CDC- or PVC-coated (CDC—cathodic dip coat, PVC—polyvinyl chloride).

According to one embodiment, the reinforcing element is coated, in particular CDC-coated, as a single part (single part CDC). As an alternative, the reinforcing element is obtained or created from a strip material which is coated on one side or both sides, in particular organically. (Organic) strip coating or coil coating methods make it possible to simplify the method, since the reinforcing element can be created quickly and efficiently by correspondingly cutting the strip material to length.

Preferably, the aforementioned coating is formed in particular on that side of the reinforcing element that is oriented toward the arrangement of the energy storage cells. This enables the indirect or direct arrangement of the energy storage cells, for example by means of adhesive bonding.

According to a preferred embodiment, the reinforcing element, that is to say in particular the steel sheet, which is CDC-coated according to a preferred embodiment, has a flat or planar form. This configuration affords the advantage that less installation space is taken up. In addition, depending on the installation position of the housing element, the center of gravity of the motor vehicle can be lowered. In this respect, the term “flat” or “planar” is not to be understood to mean that the reinforcing element/steel sheet cannot have any beads or edges for selective mechanical stiffening. Preferably, however, the reinforcing element or steel sheet does not have a profiled structure, chamber structure, hollow structure or the like.

What has been said applies analogously and correspondingly to the outer wall in the arrangement region, the outer wall likewise preferably having a flat or planar form in the aforementioned sense.

According to a preferred embodiment, a ratio of a wall thickness of the inner wall to the outer wall in the arrangement region is 0.08 to 0.9, in particular 0.1 to 0.6 or 0.2 to 0.5. Tests have shown that an optimum power-to-weight ratio can be achieved in the range of the aforementioned ratios. This means that a housing element in the production of which the aforementioned ratios were taken into account withstands the highest mechanical loads and also has a low weight.

According to one embodiment, the reinforcing element/steel sheet has a wall thickness of 0.5 to 1.2 mm. According to one embodiment, the aluminum sheet in the arrangement region has a wall thickness of 1.5 to 3.5 mm. An adhesive layer formed in between has a thickness of preferably 0.3 to 0.7 mm.

According to one embodiment, the reinforcing element, in particular the steel sheet, has a wall thickness of preferably 0.8 to 1.2 mm, in particular preferably of approximately 1 mm. The aluminum sheet in this respect in the arrangement region preferably has a wall thickness in a range from 1.5 to 2.5 mm, in particular preferably in a range from 1.7 to 2.3, very particularly preferably of approximately 2 mm.

According to one embodiment, the reinforcing element has a thickness of 0.5 to 0.9 mm, in particular preferably of 0.7 mm. The aluminum sheet in the arrangement region has a wall thickness of preferably 1.5 to 2.5 mm, particularly preferably in a range from 1.7 to 2.3 mm, very particularly preferably of 2 mm.

According to one embodiment, the reinforcing element/steel sheet has a wall thickness of 0.5 to 0.9 mm, particularly preferably of 0.7 mm. According to one embodiment, the aluminum sheet in the arrangement region has a wall thickness of 2.5 to 3.5 mm, particularly preferably of 2.7 to 3.3 mm, very particularly preferably of 3 mm.

In particular in the event of use of a high-strength steel material, the aforementioned lower limits can be reduced to 0.3 mm.

In the case of the three embodiments mentioned above, it holds true that an adhesive layer, which according to one embodiment is used to connect the outer wall and the inner wall, is preferably 0.3 to 0.7 mm or in particular preferably is 0.5 mm.

According to one embodiment, the reinforcing element is fastened to the outer wall at least partially in form-fitting and/or force-fitting and/or integrally bonded fashion. Expediently, the reinforcing element is fastened to the outer wall rotationally fixedly and/or in shearing-resistant fashion. The fastening may be areal or in certain regions, such as at certain points.

According to one embodiment, the reinforcing element is fastened to the outer wall by means of adhesive tape, by means of adhesive, by punch riveting and/or crimping.

According to one embodiment, the outer wall and the inner wall are fastened by means of adhesive over the entire surface area; cf. the aforementioned examples.

According to one embodiment, the outer wall in the arrangement region has integrally formed rivets or rivet elements. These are expediently designed to be inserted in corresponding openings of the reinforcing element or the steel sheet and to be correspondingly deformed. The integral shaping of the rivets affords the advantage that the outer wall is not “destroyed”, for example by making holes or the like. If holes are made in the outer wall, they should expediently be protected against corrosion, for example by means of application of PVC, etc.

According to one embodiment, the housing element comprises or has a middle part which forms or at least partially forms the arrangement region, wherein end parts are fastened to each end face of the middle part. Expediently, the housing element as such has an expediently three-part structure, specifically the aforementioned middle part and two respective end parts.

The housing element as such expediently has a trough shape. By way of the trough shape, the necessary volume of the arrangement region that is required for the arrangement of the greatest possible number of energy storage cells is advantageously created. In the present case, use is preferably made of prismatic cells, very particularly preferably round cells, which according to one embodiment are arranged in particular upright in the arrangement region.

According to a preferred embodiment, the end parts are cast parts, in particular die-cast aluminum parts. As an alternative, they are metal sheet components, in particular aluminum sheet components, from which expediently the middle part is also shaped.

According to a preferred embodiment, the middle part is in the form of a shaped, for example flanged, aluminum-sheet trough, which has the arrangement region and two side walls. This shape is expediently continued over the end parts, with the result that as a whole a trough-shaped housing element is formed.

Expediently, the housing element around the periphery has a flange region which in particular is designed for the form-fitting and/or force-fitting fastening of a further housing element, for example a cover element. According to one embodiment, the flange region is oriented parallel to the arrangement region. The cover element may be made from a metallic or non-metallic material. The use of composite materials may also be advantageous here.

The end parts are expediently fastened to the middle part in form-fitting and/or force-fitting and/or integrally bonded fashion.

According to a preferred embodiment, the connection/fastening is effected by means of fusion welding, in particular MIG welding (MIG—metal inert gas welding).

The basic aluminum structure makes it possible to produce the end parts in aluminum sheet and aluminum cast part by means of MIG welding, depending on requirements and complexity. Already in the event of use of casting technology can further integration potentials be brought to bear. In particular, for example, further functions may be integrated in the end parts, such as holders (holding elements), fastening points, etc.

According to a preferred embodiment, the housing element is a housing lower part of an electrical energy store housing.

The invention also relates to an electrical energy store housing comprising a housing element according to the invention, wherein the housing element is a housing lower part to which a housing upper part is fastened, in particular detachably.

The invention also relates to a method for producing a housing element, comprising the following steps:
producing a housing element comprising an arrangement region for the arrangement of a multiplicity of energy storage cells from a light-metal sheet, in particular an aluminum sheet;
reinforcing the arrangement region by arranging a reinforcing element, in particular made of a steel sheet.

Expediently, the steel sheet or the steel layer constitutes a functional reinforcement of the light-metal/aluminum structure. The steel layer has good thermal protection in the event of battery cell short circuits, upon which temperatures of 1000° C. and more can be reached. The structure also offers further potentials in terms of the end parts at the front and rear. The basic aluminum structure makes it possible to produce the connection components in aluminum sheet and/or aluminum cast part by means of MIG welding, depending on requirements and complexity. Already in the event of use of casting technology can further integration potentials be brought to bear.

Preferably, the method comprises the following steps:
forming a middle part;
arranging end parts on the middle part to produce the housing element;
inserting the reinforcing element.

According to a preferred embodiment, the housing element as such has a three-part form, comprising the middle part and two end parts. The reinforcing element is preferably inserted and fastened after the end parts have been joined. The three-part structure is advantageous since it enables, for example, a very simple configuration of the middle part as shaped or flanged light-metal sheet. The end parts may for example be produced by casting, in particular die casting. Expediently, the same material is used as for the middle part, although it does not have to be exactly the same alloy.

Preferably, the energy storage cells are fastened on the reinforcing element in integrally bonded fashion, in particular by means of adhesive. Preferably, the reinforcing element has a coating facing the energy storage cells that serves as adhesive surface. The coating is for example a CDC coating, in particular an anti-corrosion coating, such as also a zinc layer or the aforementioned organic coating mentioned in connection with the coated strip material.

According to one embodiment, an intermediate element is arranged on the reinforcing element, according to one embodiment in integrally bonded fashion, wherein the energy storage cells are arranged/fastened on the intermediate element, preferably in integrally bonded fashion. According to one embodiment, the intermediate element, which preferably has a plate-shaped form, is formed or made from a plastic, for example a foamed plastic, such as EPP (expanded polypropylene).

Further advantages and features will emerge from the following description of embodiments of housing elements with reference to the appended figures.

### BRIEF DESCRIPTION OF THE DRAWINGS

FIG. 1 is a schematic plan view of one embodiment of a housing element;

FIG. 2 shows the section A-A, as indicated in FIG. 1;

FIG. 3 shows the section B-B, as indicated in FIG. 1.

### DETAILED DESCRIPTION OF THE DRAWINGS

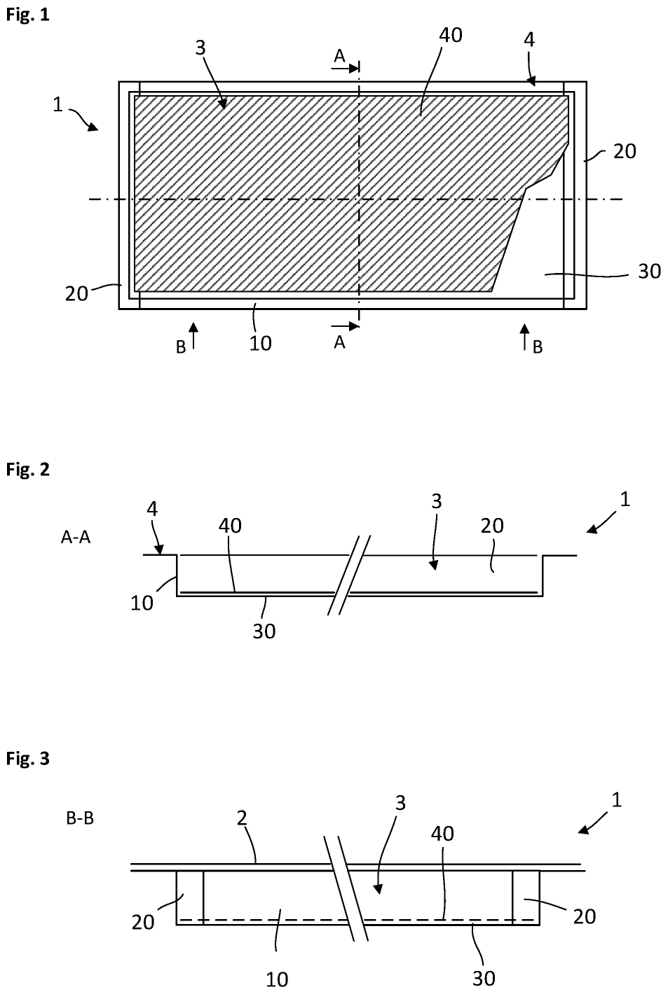

FIG. 1 schematically shows a plan view of a housing element 1, in the present case in particular a housing lower part of an energy store housing, such as a high-voltage store housing of a motor vehicle, which comprises a middle part 10 and two end parts 20. The housing element 1 has an arrangement region 3 in which a reinforcing element 40, in particular preferably a steel sheet, is arranged or fastened. In the present case, the reinforcing element 40, which forms an inner wall 40 in the arrangement region 3, is illustrated only in part, with the result that an outer wall 30 of the housing element 1 is visible at least in the lower right region. A flange region 4 is formed around the periphery of the housing element 1, in particular for the purpose of arranging a housing upper part, which is not shown here. Further features are explained in connection with FIGS. 2 and 3.

FIG. 2 shows the section A-A as outlined in FIG. 1. The middle part 10, which has the inner wall 40 and the outer wall 30 in the arrangement region, can be seen. In this view, in particular the trough-shaped configuration of the middle part can be seen, with corresponding side walls (not provided with a reference sign) extending away, in the present case upward, substantially perpendicularly in relation to the arrangement region 3. The flange region 4 around the periphery can be seen.

FIG. 3 shows the section B-B. The housing element 1 is illustrated from the side in the present case. The outer wall 30 and the inner wall 40 in the arrangement region 3 (illustrated in dashed line) can also be seen here. It can be seen that the end parts 20 are formed in such a way that they at least partially conjointly form the arrangement region 3. Reference sign 2 denotes a housing upper part that is fastened to the housing element 1, preferably in the form of the housing lower part, expediently in form-fitting and/or force-fitting fashion.

### LIST OF REFERENCE SIGNS

1 Housing element, housing lower part
2 Housing upper part
3 Arrangement region
4 Flange region
10 Middle part
20 End part
30 Outer wall
40 Inner wall, reinforcing element

1.-13. (canceled)

14. A housing element for an energy store housing, comprising:
an arrangement region, which is designed for arrangement of a multiplicity of energy storage cells,
wherein the arrangement region of the housing element has a double-walled form comprising an outer wall and an inner wall,
wherein the outer wall is formed by a light-metal sheet, and
wherein the inner wall is formed by a reinforcing element arranged on the outer wall.

15. The housing element according to claim 14, wherein
the light-metal sheet is an aluminum sheet.

16. The housing element according to claim 14, wherein
the reinforcing element is a steel sheet.

17. The housing element according to claim 16, wherein
the reinforcing element is flat or planar.

18. The housing element according to claim 14, wherein
a ratio of a wall thickness of the inner wall to the outer wall is 0.2 to 0.6.

19. The housing element according to claim 14, wherein
the reinforcing element is at least partially fastened to the outer wall in form-fitting, force-fitting, and/or integrally bonded connection.

20. The housing element according to claim 19, wherein
the reinforcing element is fastened to the outer wall via at least one of: adhesive tape, an adhesive, punch riveting, or crimping.

21. The housing element according to claim 14, wherein
the housing element comprises a middle part, which forms the arrangement region, and
end parts of the housing element are fastened to each end face of the middle part.

22. The housing element according to claim 20, wherein
the housing element has a trough-shaped form.

23. The housing element according to claim 21, wherein
the end parts are die-cast aluminum parts.

24. The housing element according to claim 14, wherein
the housing element is a housing lower part of an electrical energy store housing.

25. An energy store housing, comprising:
a housing lower part comprising an arrangement region, which is designed for arrangement of a multiplicity of energy storage cells,
wherein the arrangement region of the housing lower part has a double-walled form comprising an outer wall and an inner wall,
wherein the outer wall is formed by a light-metal sheet, and
wherein the inner wall is formed by a reinforcing element arranged on the outer wall; and
a housing upper part which is detachably fastened to the housing lower part.

26. A method for producing a housing element, comprising the steps of:
producing, from a light metal sheet, an outer wall of arrangement region of the housing element for arrangement of a multiplicity of energy storage cells; and
reinforcing the arrangement region with a reinforcing element made of a steel sheet arranged on the outer wall to form an inner wall of the arrangement region.

27. The method according to claim 26, wherein
the producing forms a middle part that includes the arrangement region;
end parts are arranged on the middle part; and
the reinforcing includes inserting the reinforcing element.
